(19) United States
(12) Patent Application Publication
(10) Pub. No.: US 2017/0045661 A1
(43) Pub. Date: Feb. 16, 2017

(54) DISPLAY DEVICE AND METHOD OF MANUFACTURING THE SAME

(71) Applicant: Samsung Display Co., Ltd., Yongin-si (KR)

(72) Inventors: Min-young SONG, Asan-si (KR); Eunju NAM, Seoul (KR); Young-min PARK, Hwaseong-si (KR)

(21) Appl. No.: 15/095,647

(22) Filed: Apr. 11, 2016

(30) Foreign Application Priority Data
Aug. 10, 2015 (KR) 10-2015-0112574

(51) Int. Cl. F21V 8/00

(52) U.S. Cl. CPC G02B 6/0013; G02B 6/0038; G02B 6/0036; G02B 6/0065

(57) ABSTRACT

A display device includes a light guide plate, a light source unit adjacent to a side surface of the light guide plate and including a printed circuit board and a light source which is on the printed circuit board, and a connection member which connects the light guide plate to the light source unit. The light guide plate, the printed circuit board and the connection member together encapsulate the light source. The connection member includes a first inclined surface which contacts an upper surface of the light guide plate. The first inclined surface forms two angles with the upper surface of the light guide plate and an angle closer to the light source unit among the two angles is an acute angle.

This application claims priority to Korean Patent Application No. 10-2015-θ112574, filed on Aug. 10, 2015, and all the benefits accruing therefrom under 35 U.S.C. §119, the content of which in its entirety is herein incorporated by reference.

### BACKGROUND

1. Field

The invention relates to a display device and a method of manufacturing the same. More particularly, the invention relates to a display device including a light source-integrated light guide plate and a method of manufacturing the display device.

2. Description of the Related Art

Various display devices, such as a liquid crystal display, a plasma display panel, an organic light emitting display, a field effect display, an electrophoretic display, etc., are widely used.

The liquid crystal display applied to a variety of electric equipment, e.g., a television set, a mobile device, a monitor, etc., includes a liquid crystal panel to display an image. To this end, the liquid crystal panel includes two substrates facing each other and a liquid crystal layer interposed between the two substrates.

Since the liquid crystal display is not self-emissive, a backlight unit including a light source emitting a light is used in the liquid crystal display. The backlight unit is disposed at a rear side of the liquid crystal panel.

The backlight unit is classified into a direct-illumination type backlight unit and an edge-illumination type backlight unit according to a position of the light source. In the direct-illumination type backlight unit, the light source is disposed under the liquid crystal panel to directly supply a light to the liquid crystal panel. In the edge-illumination type backlight unit, a light guide plate is disposed under the liquid crystal panel and the light source is disposed adjacent to a side of the light guide plate, and thus the light emitted from light source is refracted and reflected by the light guide plate and the light is supplied to the liquid crystal panel through the light guide plate.

### SUMMARY

One or more exemplary embodiment of the invention provides a display device having reduced thickness, superior shielding characteristics of an optical pattern and superior light efficiency.

One or more exemplary embodiment of the invention provides a method of manufacturing the display device.

Exemplary embodiments of the present disclosure provide a display device including a light guide plate, a light source unit adjacent to a side surface of the light guide plate, the light source unit including a printed circuit board and a light source which is on the printed circuit board; and a connection member which connects the light guide plate and the light source unit to each other. The light guide plate, the printed circuit board and the connection member together encapsulate the light source, the connection member includes a first inclined surface thereof which contacts an upper surface of the light guide plate, and the first inclined surface forms two angles with the upper surface of the light guide plate and an angle closer to the light source unit among the two angles is an acute angle.

The connection member may include a first sub-connection portion thereof above the light guide plate and overlapped with the light guide plate in a plan view, the first sub-connection portion including the first inclined surface; a second sub-connection portion thereof under the light guide plate and overlapped with the first sub-connection portion in the plan view, and a third sub-connection portion thereof extended from the first sub-connection portion and overlapped with the light source in the plan view.

The first sub-connection portion may have a trapezoid shape or a triangular shape in a cross-section thereof.

The connection member may further include a second inclined surface thereof which contacts a lower surface of the light guide plate opposite to the upper surface thereof, the second sub-connection portion including the second inclined surface, and the second inclined surface forms two angles with the lower surface of the light guide plate and an angle adjacent to the light source unit among the two angles is an acute angle.

The second sub-connection portion may have a trapezoid shape or a triangular shape in a cross-section thereof.

The connection member may further include a fourth sub-connection portion extended from the third sub-connection portion and spaced apart from the first and second sub-connection portions.

The connection member may further include a fourth sub-connection portion extended from the second sub-connection portion and spaced apart from the first and third sub-connection portions.

The light guide plate and the light source may be spaced apart from each other and the connection member may further include a fifth sub-connection portion disposed between the light guide plate and the light source spaced apart from each other.

The light guide plate may make contact with the light source.

The light guide plate may be extrusion-molded plate.

The light guide plate may have a thickness equal to or greater than about 100 micrometers and equal to or smaller than about 500 micrometers.

At least one of the upper surface and a lower surface of the light guide plate opposite to the upper surface thereof may include an optical pattern lengthwise extending in a first direction and arranged in a second direction perpendicular to the first direction.

The optical pattern may have a lenticular shape or a prism shape.

The light guide plate and the connection member may include different materials from each other.

Exemplary embodiments of the present disclosure provide a method of manufacturing a display device, including preparing a light guide plate formed by an extrusion molding process, preparing a light source unit including a printed circuit board and a light source which is disposed on the printed circuit board, preparing a mold including an inclined surface, providing the light source unit and a portion of the extrusion-molded light guide plate in the mold including the inclined surface, and filling the mold having the light source unit and the portion of the extrusion-molded light guide plate therein with a resin to form a connection member which together with the light guide plate and the printed circuit board encapsulates the light source.

The mold may includes a first surface, a second surface facing the first surface, and a third surface which connects first ends of the first surface and the second surface to each other. The first surface may include a first sub-surface thereof extended from the third surface and a second sub-surface thereof extended from the first sub-surface and inclined to the second surface. In a plan view, the first sub-surface may not be overlapped with the second sub-surface.

The second surface may include a first sub-surface thereof extended from the third surface and a second sub-surface thereof extended from the first sub-surface of the second surface and inclined with respect to the first surface. In the plan view, the first sub-surface of the second surface may not be overlapped with the second sub-surface of the second surface.

The preparing the light guide plate may include forming an optical pattern lengthwise extending in a first direction and arranged in a second direction perpendicular to the first direction, on at least one surface of the light guide plate.

According to the above, one or more exemplary embodiment of the display device manufactured by the above-mentioned method may have a reduced thickness, superior shielding characteristics by the optical pattern and superior light efficiency.

In addition, since the manufacturing method does not employ a separate cutting process, defects in the light guide plate, e.g., a size error caused by errors in cutting, a crack propagation during the cutting process, etc., may be reduced or effectively prevented.

### BRIEF DESCRIPTION OF THE DRAWINGS

The above and other advantages of the present disclosure will become readily apparent by reference to the following detailed description when considered in conjunction with the accompanying drawings where:

FIG. 1 is an exploded perspective view showing an exemplary embodiment of a display device according to the invention;

FIG. 2 is a cross-sectional view of an exemplary embodiment of a backlight unit included in a display device taken along line I-I′ of FIG. 1 according to the invention;

FIG. 3 is a cross-sectional view of a backlight unit included in a display device taken along line I-I′ of FIG. 1, for which portions of a connection member are detailed according to the invention;

FIG. 4 is a view showing portions of the backlight unit of FIG. 3 in an un-assembled state thereof;

FIG. 5 is a cross-sectional view of another exemplary embodiment of a backlight unit included in a display device taken along line I-I′ of FIG. 1 according to the invention;

FIG. 6 is a cross-sectional view of still another exemplary embodiment of a backlight unit included in a display device taken along line I-I′ of FIG. 1 according to the invention;

FIG. 7 is a view showing portions of the backlight unit of FIG. 6 in an un-assembled state thereof;

FIG. 8 is a cross-sectional view showing of yet another exemplary embodiment of a backlight unit included in a display device taken along line I-I′ of FIG. 1 according to the invention;

FIG. 9 is a cross-sectional view of yet another exemplary embodiment of a backlight unit included in a display device taken along line I-I′ of FIG. 1 according to the invention;

FIG. 10A is a perspective view showing an exemplary embodiment of a light guide plate as viewed relative to line A-A′ of FIG. 2 according to the invention;

FIG. 10B is a perspective view showing another exemplary embodiment of a light guide plate as viewed relative to line A-A′ of FIG. 2 according to the invention;

FIG. 11 is a flowchart showing an exemplary embodiment of a method of manufacturing a display device according to the invention;

FIGS. 12A to 12C are cross-sectional views showing operations in an exemplary embodiment of a method of manufacturing a display device according to the invention; and

FIG. 13 is a view showing an exemplary embodiment of a mold applied in a method of manufacturing a display device according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an” and “the” are intended to include the plural forms as well, unless the context clearly indicates otherwise. As used herein, the term “and/or” includes any and all combinations of one or more of the associated listed items. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, the invention will be explained in detail with reference to the accompanying drawings.

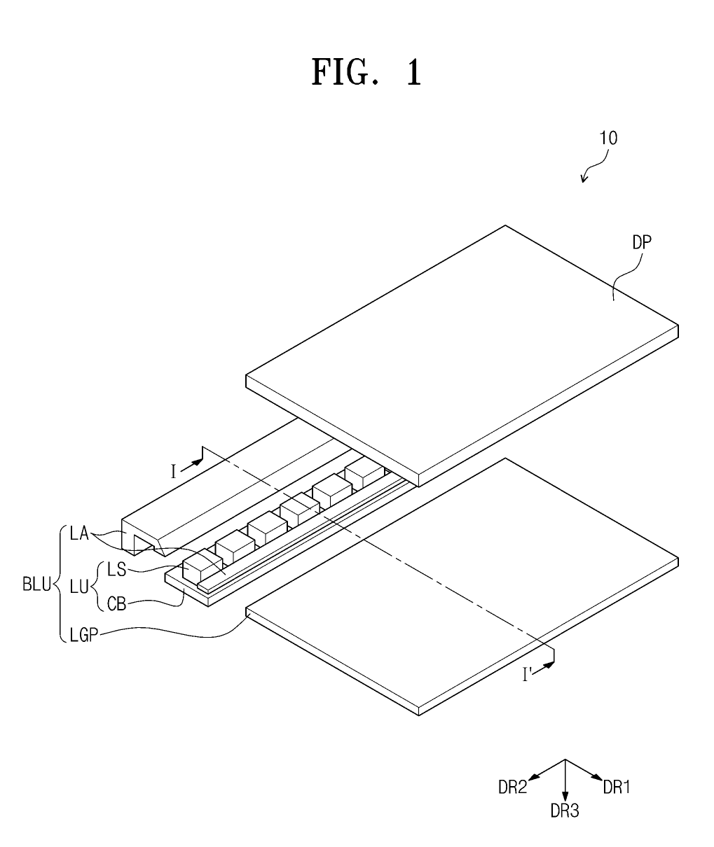

FIG. 1 is an exploded perspective view showing an exemplary embodiment of a display device 10 according to the invention.

Referring to FIG. 1, the display device 10 includes a backlight unit BLU and a display panel DP.

The backlight unit BLU includes a light source unit LU and a light guide plate LGP. The light source unit LU generates and emits a light. The light source unit LU may emit a white light. The light source unit LU and the light guide plate LGP, which are included in the display device 10, are integrated with each other by a connection member LA in a single unitary and individual unit. That is, the backlight unit BLU included in the display device 10 includes the light source unit LU integrated within the light guide plate LGP. The light source unit LU, the light guide plate LGP and the connection member LA will be described in detail later.

The backlight unit BLU of the display device 10 is an edge-illumination type backlight unit. As shown in FIG. 1, the light guide plate LGP is disposed under the display panel DP and the light source unit LU is disposed adjacent to a side surface of the light guide plate LGP.

Although not shown in figures, an optical member may be further provided between the display panel DP and the light guide plate LGP. The optical member improves brightness and viewing angle of a light exiting from a light exit surface of the light guide plate LGP. The optical member may include first, second and third optical members sequentially stacked one on another.

The first optical member may be, but not limited to, a diffusion sheet to diffuse the light exiting from the light guide plate LGP. The second optical member may be, but not limited to, a prism sheet to condense the light diffused by the diffusion sheet in a direction substantially vertical to a plane surface of the display panel DP. The third optical member may be, but not limited to, a protective sheet to protect the prism sheet from external impacts. In the exemplary embodiment, at least one of the first, second and third optical members may be provided in plural number, or one or more of the first to third optical members may be omitted from the optical member.

Although not shown in figures, the backlight unit BLU may further include a reflective sheet. The reflective sheet is disposed under the light guide plate LGP. The reflective sheet reflects the light leaking from the display panel DP and not directed to the display panel DP to allow the reflected light to travel to the display panel DP. Accordingly, an amount of the light traveling to the display panel DP is enhanced by the reflective sheet.

Although not shown in figures, the display device 10 may further include a bottom chassis. The bottom chassis is disposed under the backlight unit BLU. The bottom chassis accommodates the backlight unit BLU and the display panel DP in a receiving space defined by the bottom chassis.

Although not shown in figures, the display device 10 may further include a mold frame. The mold frame is disposed between the display panel DP and the backlight unit BLU. The mold frame is disposed under the display panel DP and provided along an edge of the display panel DP to support the display panel DP.

The display panel DP is disposed on the backlight unit BLU. The display panel DP is a non-self-emissive display panel, to which light is provided by a separate backlight unit BLU, different from a self-emissive display panel such as an organic light emitting display panel. In exemplary embodiments, for instance, various display panels, e.g., a liquid crystal display panel, an electrophoretic display panel, etc., may be used as the display panel DP. Hereinafter, the liquid crystal display panel will be described as the display panel DP.

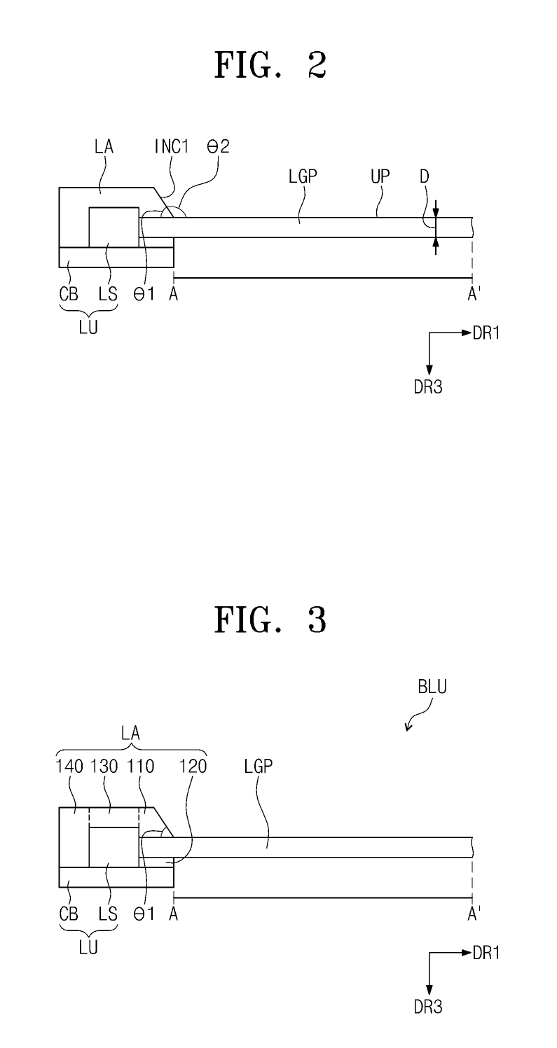

FIG. 2 is a cross-sectional view taken along line I-I′ of FIG. 1. In detail, FIG. 2 shows a cross-sectional view of an exemplary embodiment of the backlight unit BLU included in the display device 10 according to the invention.

Referring to FIG. 2, the display device 10 includes the light guide plate LGP, the light source unit LU disposed adjacent to a side surface of the light guide plate LGP, and the connection member LA connecting the light guide plate LGP and the light source unit LU to each other. The connection member LA fixes a position of the light guide plate LGP with respect to a position of the light source unit LU.

The light guide plate LGP and the light source unit LU are coupled to each other and positions thereof relative to each other are fixed by the connection member LA. That is, the display device 10 includes the light guide plate LGP with which the light source unit LU is integrated.

The light source unit LU includes a printed circuit board CB and at least one light source LS disposed on a surface of the printed circuit board CB.

The printed circuit board CB applies a power source voltage to the light source LS. The light source LS may be, but not limited to, a light emitting diode (“LED”). The light source LS may be provided in a plural number and the light sources LS may be arranged on the printed circuit board CB and spaced apart from each other in a second direction DR2 (refer to FIG. 1). The light source unit LU of the display device 10 may be realized in an LED chip or an LED package.

The light source LS is encapsulated by the light guide plate LGP, the printed circuit board CB and the connection member LA. An entirety of the light source LS is encapsulated by the light guide plate LGP, the printed circuit board CB and the connection member LA. All surfaces of the light source LS make contact with at least one of the light guide plate LGP, the printed circuit board CB and the connection member LA, and thus the light source LS is not exposed to outside the light source unit LU. Where the light source LS is provided in a plural number, each light source LS is encapsulated by the light guide plate LGP, the printed circuit board CB and the connection member LA such that the light sources LS are not exposed to outside the light source unit LU.

The connection member LA includes a first inclined surface INC1 making contact with or meeting an upper surface UP of the light guide plate LGP. Two angles θ1 and θ2 are defined by the first inclined surface INC1 and the upper surface UP of the light guide plate LGP. Among the two angles θ1 and θ2, the angle θ1 adjacent to the light source unit LU is an acute angle. In more detail, among the two angles θ1 and θ2, the angle θ1 adjacent to the light source LS is an acute angle. A portion of the connection member LA has a tapered shape due to the first inclined surface INC1. Portions of the connection member LA include or define the first inclined surface INC1.

The upper surface UP of the light guide plate LGP may serve as the light exit surface thereof from which the light incident into the light guide plate LGP exits.

Referring to FIG. 3, the connection member LA includes a first sub-connection portion 110, a second sub-connection portion 120 and a third sub-connection portion 130. The first sub-connection portion 110 is disposed on the light guide plate LGP and overlapped with a portion of the light guide plate LGP in a plan view. The second sub-connection portion 120 is disposed under the light guide plate LGP and overlapped with the first sub-connection portion 110 in the plan view. The third sub-connection portion 130 is connected to the first sub-connection portion 110 and overlapped with the light source LS in the plan view. The third sub-connection portion 130 is spaced apart from the second sub-connection portion 120.

In the exemplary embodiments, the term “in the plan view” used herein means a thickness direction DR3 of the display device 10 unless another definition is provided.

The first sub-connection portion 110 may include or define the first inclined surface INC1. The first sub-connection portion 110 may have a tapered shape.

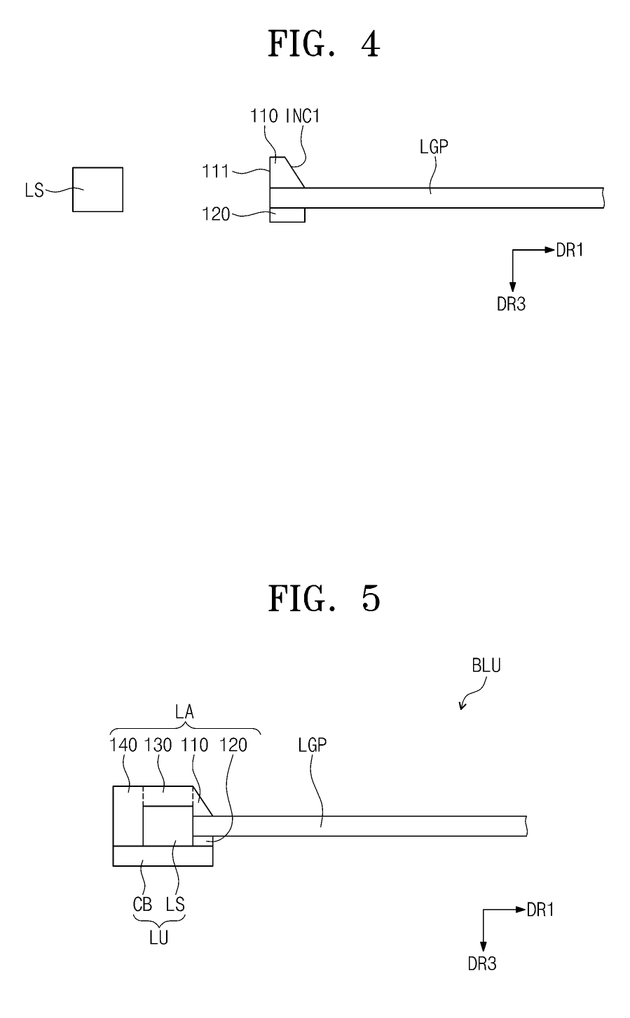

Referring to FIG. 4, the first sub-connection portion 110 includes or defines a first surface 111 facing the light source LS. The first surface 111 of the first sub-connection portion 110 is substantially parallel to a surface of the light source LS, such as a light emitting surface thereof, which faces the first surface 111. The first sub-connection portion 110 has a trapezoid shape in a cross-section thereof, but should not be limited thereto or thereby. As shown in FIG. 5, another exemplary embodiment of the first sub-connection portion 110 may have a triangular shape in a cross-section thereof. The second sub-connection portion 120 may have a quadrangular shape in a cross-section thereof.

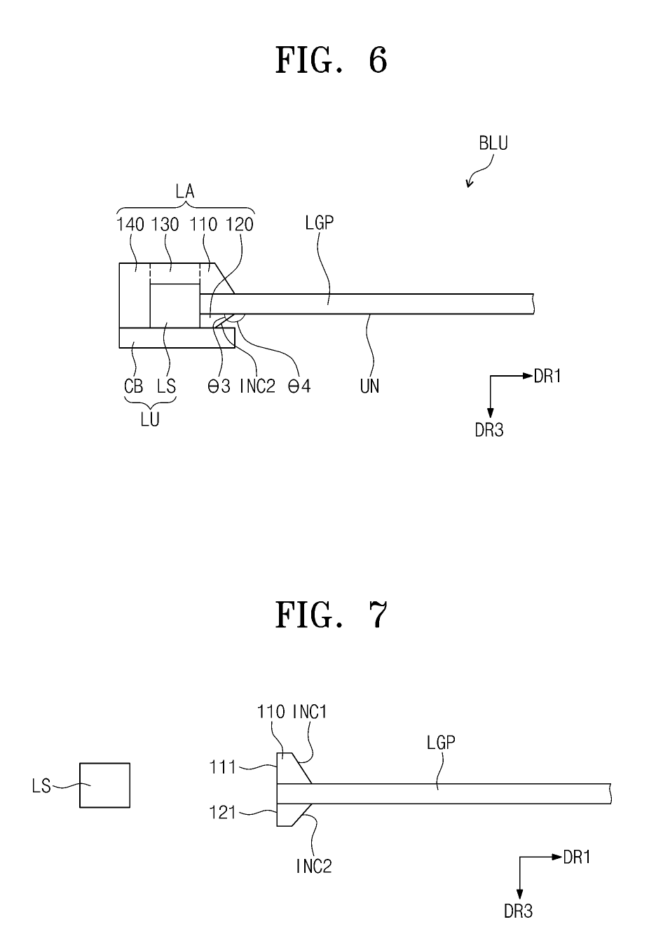

Referring to FIG. 6, the connection member LA may further include or define a second inclined surface INC2 making contact with or meeting a lower surface UN of the light guide plate LGP. Among two angles θ3 and θ4 defined by the second inclined surface INC2 and the lower surface UN of the light guide plate LGP, the angle θ3 adjacent to the light source unit LU is an acute angle. In more detail, among the two angles θ3 and θ4, the angle θ3 adjacent to the light source LS is an acute angle.

The lower surface UN of the light guide plate LGP opposes the upper surface UP of the light guide plate LGP. The lower surface UN of the light guide plate LGP may correspond to a rear surface of the light guide plate LGP which opposes the light exiting surface thereof.

The second sub-connection portion 120 may include or define the second inclined surface INC2. The second sub-connection portion 120 may have a tapered shape due to the second inclined surface INC2.

Referring to FIG. 7, the second sub-connection portion 120 includes a first surface 121 facing the light source LS. The first surface 121 of the second sub-connection portion 120 is substantially parallel to a surface of the light source LS, such as a light emission surface thereof, which faces the second sub-connection portion 120. The second sub-connection portion 120 has a trapezoid shape in a cross-section thereof, but should not be limited thereto or thereby. Although not shown in figures, the second sub-connection portion 120 may have a triangular shape in a cross-section thereof.

Referring to FIGS. 3, 5 and 6, the connection member LA may further include a fourth sub-connection portion 140. The fourth sub-connection portion 140 is connected to the third sub-connection portion 130 and spaced apart from the first sub-connection portion 110. The fourth sub-connection portion 140 is spaced apart from the second sub-connection portion 120.

The light source unit LU may be a side emission type. When the side emission type light source unit LU is applied to the display device 10, a thickness of the display device 10 may be more reduced than that when a top emission type light source unit is applied to the display device 10.

In detail, the printed circuit board CB is disposed to extend under the light guide plate LGP, a portion of the extended printed circuit board CB is overlapped with a portion of the light guide plate LGP in the plan view, and the second sub-connection portion 120 is disposed between the extended portion of the printed circuit board CB and the light guide plate LGP.

The fourth sub-connection portion 140 is overlapped with the printed circuit board CB and not overlapped with the light source LS in the plan view. That is, the fourth sub-connection portion 140 is disposed on a portion of the printed circuit board CB, on which the light source LS is not disposed. In a conventional top emission type light source unit, a separate adhesive member such as an adhesive tape may be provided between a printed circuit board and a light guide plate to connect the light guide plate and a light source unit to each other. However, in one or more exemplary embodiment of the display device 10, no additional adhesive member is required since the second sub-connection portion 120 of the connection member LA is disposed between the light guide plate LGP and the printed circuit board CB to connect the light guide plate LGP and the light source unit LU to each other and to fix positions thereof relative to each other.

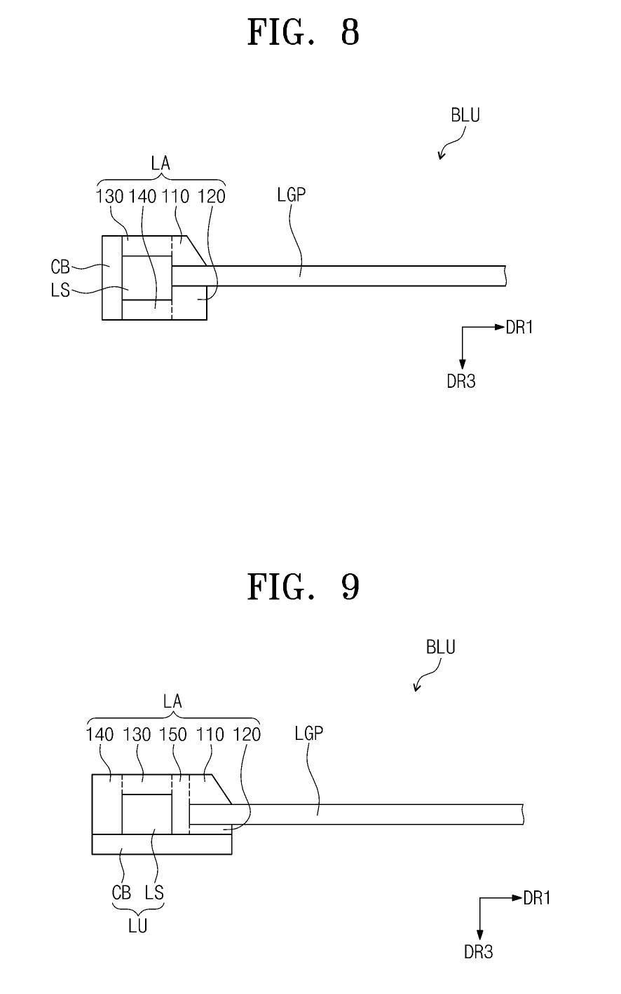

The light source unit LU may be the top emission type but should not be limited thereto or thereby. Referring to FIG. 8, the printed circuit board CB is not overlapped with the light guide board LGP in the plan view and the light source LS is disposed between the printed circuit board CB and the light guide plate LGP to provide a side emission type light source unit LU.

The printed circuit board CB may be disposed at one side portion of the light guide plate LGP. With the printed circuit board CB disposed at the side portion of the light guide plate LGP, the fourth sub-connection portion 140 may be spaced apart from the first and second sub-connection portions 110 and 130 with the light source LS therebetween. The fourth sub-connection portion 140 is overlapped with the light source LS and not overlapped with the printed circuit board CB in the plan view.

As shown in FIGS. 2, 3, 5, 6 and 8, the light guide plate LGP and the light source LS may make contact with each other, but should not be limited thereto or thereby.

Referring to FIG. 9, the light guide plate LGP and the light source LS may be disposed to be spaced apart from each other (e.g., non-contacting). The connection member LA may further include or define a fifth sub-connection portion 150 disposed between the light guide plate LGP and the light source LS. The fifth sub-connection portion 150 is connected to the first sub-connection portion 110, the second sub-connection portion 120 and the third sub-connection portion 130. When the light source unit LU is the top emission type, such as illustrated in FIG. 9, the fifth sub-connection portion 150 may be spaced apart from the fourth sub-connection portion 140. When the light source unit LU is the side emission type referring to FIG. 8, the fifth sub-connection portion 150 may be connected to the fourth sub-connection portion 140 such as being disposed between the fourth sub-connection portion 140 and the third sub-connection portion 130.

In general, the light guide plate LGP may be manufactured by an extrusion molding method or an injection molding method. The injection molding method has advantages in that the light guide plate can be freely manufactured into desired shapes as compared with the extrusion molding method. However, the injection molding method has disadvantages in that realizing a relatively small thickness may be difficult.

In an exemplary embodiment of manufacturing the display device 10, the light guide plate LGP of the display device 10 is formed by the extrusion molding method to meet the trend of a relatively thin and compact display device 10. In detail, the light guide plate LGP has a total or maximum thickness D (refer to FIG. 2) equal to or greater than about 100 micrometers and equal to or smaller than about 500 micrometers. In more detail, the thickness D of the light guide plate LGP is in a range equal to or greater than about 100 micrometers and equal to or smaller than about 400 micrometers. Where the thickness D of the light guide plate LGP is smaller than about 100 micrometers, a mechanical strength of the light guide plate LGP may be weakened, and where the thickness D of the light guide plate LGP exceeds about 500 micrometers, the advantages of the thin thickness of the display device 10 including such relatively thick light guide plate LGP may be lost.

Referring again to FIG. 3, the first surface 111 of the first sub-connection portion 110 which faces the light source LS, the first surface 121 of the second sub-connection portion 120, and the side surface (e.g., light incident surface) of the light guide plate LGP which faces the light source LS, are connected to each other to form a collective light incident surface of the backlight unit BLU. The first surface 111 of the first sub-connection portion 110, the first surface 121 of the second sub-connection portion 120 and the light incident surface) of the light guide plate LGP may be coplanar with each other to define the light incident surface of the backlight unit BLU. A length in the thickness direction DR3 of the light incident surface of the backlight unit BLU is greater than a length in the thickness direction DR3 of the surface of the light source LS (e.g., the emission surface thereof) which faces the light incident surface. Although the thickness D of the light guide plate LGP is reduced by the extrusion molding method, loss of the light may be reduced because of the length in the thickness direction DR3 of the light incident surface of the backlight unit BLU being greater than the length in the thickness direction DR3 of the surface of the light source LS (e.g., the emission surface thereof) which faces the light incident surface.

In addition, since the first surface 111 of the first sub-connection portion 110 which faces the light source LS, the first surface 121 of the second sub-connection portion 120, and the side surface of the light guide plate LGP which faces the light source LS which faces the light source LS, form a single light incident surface of the backlight unit BLU, a light incident efficiency of light transmitted into the light guide plate LGP may be more improved. In a conventional backlight unit where the above three surfaces are not connected to or coplanar with each other to form interfaces therebetween, light emitted from the light source unit LU may be returned to the light source unit LU after being reflected by the three surfaces.

That is, in one or more exemplary embodiment of the invention, the first and second sub-connection portions 110 and 120 included in the connection member LA connect the light guide plate LGP to the light source unit LU within the backlight unit BLU to reduce the light loss. Thus the light emitted from the light source unit LU is effectively incident to the light guide plate LGP.

Where the light guide plate LGP and the light source LS are spaced apart from each other as shown in FIG. 9, a surface of the fifth sub-connection portion 150 which faces the light source LS, may define the light incident surface of the backlight unit BLU. The surface of the fifth sub-connection portion 150 which faces the light source LS, may define an entirety of the light incident surface of the backlight unit BLU. A length in the thickness direction DR3 of the surface of the fifth sub-connection portion 150 which faces the light source LS, is greater than a length of the surface of the light source LS (e.g., light emission surface) which faces the light incident surface. As described above, even though the thickness D of the light guide plate LGP is reduced by the extrusion molding method, loss of the light may be reduced because of the length in the thickness direction DR3 of the light incident surface being greater than the length in the thickness direction DR3 of the surface of the light source LS (e.g., the emission surface thereof) which faces the light incident surface. Thus, the relatively thin thickness of the display device 10 may be realized, and substantially simultaneously, the reduction of the light loss may be minimized.

The light guide plate LGP and the connection member LA may include different materials from each other as long as they have similar refractive indices to each other.

The light guide plate LGP includes or is formed of a material having a refractive index of about 1.5. In an exemplary embodiment, for instance, the light guide plate LGP includes or is formed of polymethylmethacrylate (“PMMA”), polycarbonate (“PC”) or polystyrene (“PS”), but should not be limited thereto or thereby.

As described above, since the portions of the connection member LA transmit therethrough the light generated and emitted from the light source unit LU to be effectively incident to the light guide plate LGP, a material of the connection member LA may be similar in refractive index to that of the light guide plate LGP. Where the materials of the connection member LA and the light guide plate have similar refractive indices, the refraction and reflection of the light may be effectively controlled, and thus the light use efficiency may be improved. The material used to form the connection member LA should not be limited to a specific material as long at the material for the connection member LA has a refractive index similar to that of the light guide plate LGP. In an exemplary embodiment, for instance, the connection member LA may include or be formed of urethane acrylate.

Although not shown in figures, the connection member LA may further include a sixth sub-connection portion disposed on or in contact with a rear surface of the printed circuit board CB opposing the surface on which the light source LS is disposed. However, in view of heat radiation from the light source unit LU, the connection member LA may not be disposed on or in contact with the rear surface of the printed circuit board CB on which the light source LS is not disposed. The light source unit LU generates heat since a temperature of the light source unit LU increases according to the time of use of the display device 10, and the increase in temperature of the light source unit LU causes an undesirable variation in brightness. When the connection member LA is not disposed on the rear surface of the printed circuit board CB on which the light source LS is not disposed, the heat generated by the light source LS may be discharged through the rear surface of the printed circuit board CB on which the light source LS is not disposed.

Although not shown in figures, the lower surface UN of the light guide plate LGP may include or define a light exit pattern. The light exit pattern refracts the light provided from the light source unit LU disposed at the side portion of the light guide plate LGP to allow the refracted light to travel to the display panel DP through the upper surface UP of the light guide plate LGP. The light exit pattern may have a variety of densities, shapes and sizes thereof. In an exemplary embodiment, for instance, the light exit pattern may have various shapes in the plan view, such as a circular shape, a triangular shape, a quadrangular shape, an oval shape, etc.

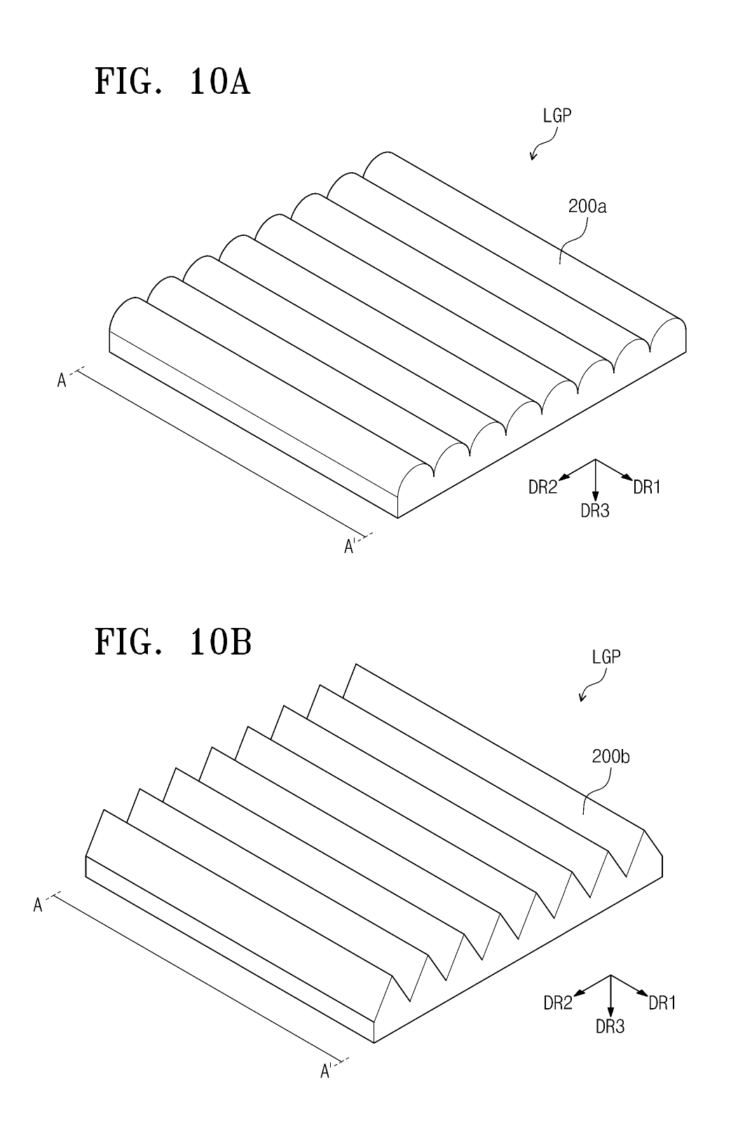

FIGS. 10A and 10B are perspective views showing exemplary embodiments of light guide plates as viewed relative to line A-A′ of FIG. 2.

Referring to FIGS. 10A and 10B, the upper surface UP of the light guide plate LGP includes or defines patterns 200a and 200b lengthwise extending in a first direction DR1 and consecutively arranged in the second direction DR2 perpendicular to the first direction DR1. An entirety of the patterns 200a and 200b may be disposed at the upper surface UP of the light guide plate LGP, but should not be limited thereto or thereby. Different from FIGS. 10A and 10B, an entirety of the patterns 200a and 200b may be defined or arranged on the lower surface UN of the light guide plate LGP or may be defined or arranged on both the upper and lower surfaces UP and UN of the light guide plate LGP according to alternative exemplary embodiments.

The patterns 200a and 200b shield the light exit pattern formed on the lower surface UN of the light guide plate LGP and/or reduce or effectively prevent white dots from being viewable at the display panel DP. The patterns 200a and 200b are defined or formed by a recess-forming pattern of an extrusion roller when the light guide plate LGP is extrusion molded.

In cross-section, the pattern 200a has a lenticular shape as shown in FIG. 10A or a prism shape 200b as shown in FIG. 10B, but should not be limited thereto or thereby. In an exemplary embodiment, for instance, the pattern may have a hairline shape (not shown).

In a conventional light guide plate that is extrusion molded, simultaneously forming an inclined surface and a shield pattern are difficult. To solve the above difficulty, a conventional method of separately forming the inclined surface such as using an ultraviolet-curing resin after the light guide plate is extrusion molded may be used. However, in the conventional method where the inclined surface is separately formed using the resin, an additional process of cutting the inclined surface is required, a cutting error occurs in the inclined surface, and the inclined surface is cracked or delaminated from the light guide plate. That is, simultaneously achieving the relatively thin thickness, the superior shielding characteristics of the optical pattern, and the superior light efficiency of the light guide plate is difficult.

However, in one or more exemplary embodiment of the display device 10 according to the invention, even though the inclined surface of the connection member LA is formed separate from the light guide plate LGP, the inclined surface defines a connecting portion which connects (e.g., fixes positions of) the light guide plate LGP and the light source unit LU to each other, and thus no additional cutting process is required, thereby reducing or effectively preventing defects caused by the conventional cutting process from occurring. Further, the shielding pattern is substantially simultaneously formed with the light guide plate LGP and the inclined surface and the shielding pattern are substantially simultaneously formed. As a result, one or more exemplary embodiment of the display device 10 according to the invention may have the relatively thin thickness, the superior shielding characteristics of the optical pattern and the superior light efficiency.

Hereinafter, an exemplary embodiment of a method of manufacturing the display device will be described in detail.

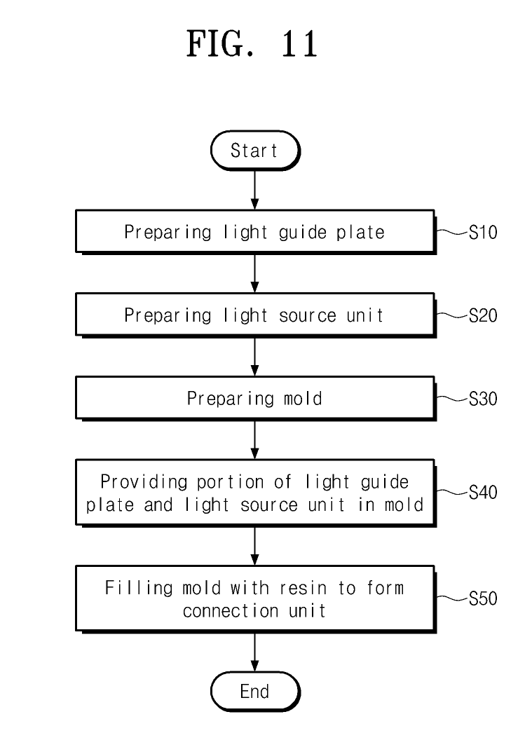

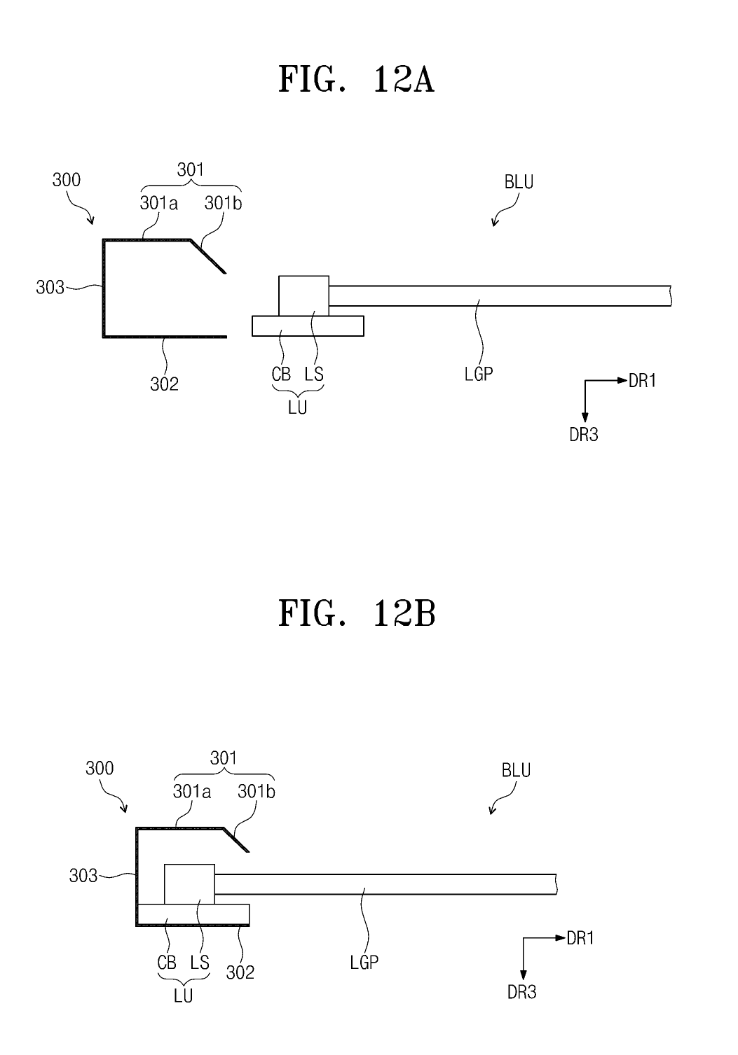

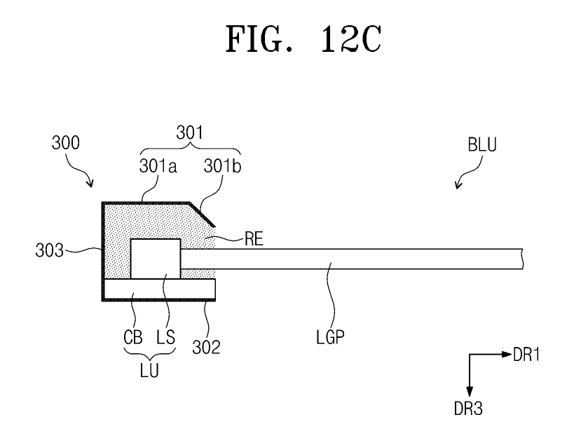

Referring to FIGS. 11 and 12A to 12C, the manufacturing method of the display device includes preparing the light guide plate LGP (S10), preparing the light source unit LU (S20), preparing a mold 300 having at least one inclined surface (S30), providing a portion of the light guide plate LGP and the light source unit LU inside the mold 300 (S40), and filling the mold 300 with a resin RE to form the connection member LA that encapsulates the light source LS together with the light guide plate LGP and the printed circuit board CB (S50).

The manufacturing method of the display device 10 should not be limited to the above-mentioned process shown in FIG. 11. That is, the preparing of the light source unit LU (S20) may be performed prior to the preparing of the light guide plate LGP (S10).

The light unit LU including the printed circuit board CB and the light source LS which is disposed on the printed circuit board CB is provided through the preparing of the light source unit LU (S20).

The manufacturing method of the display device 10 may further include removing the mold 300 after the forming of the connection member LA (S50).

Referring to FIGS. 12A to 12C, the mold 300 includes or defines a first surface 301, a second surface 302 and a third surface 303.

The first surface 301 includes or defines a first sub-surface 301a connecting the third surface 303 to a second sub-surface 301b which extends from the first sub-surface 301a and is inclined with respect to the second surface 302. The first sub-surface 301a may be substantially parallel to the second surface 302. The second sub-surface 301b is not parallel to the second surface 302. The first sub-surface 301a and the second sub-surface 301b are not overlapped with each other in the plan view, that is, in a direction from the first surface 301 to the second surface 302.

Where the connection member LA is formed by filling the mold 300 having the second sub-surface 301b of the first surface 301 with the resin RE, a portion of the connection member LA is formed as the inclined surface (refer to FIG. 2). In more detail, the portion of the connection member LA includes or defines the inclined surface which contacts or meets the upper surface UP (refer to FIG. 2) of the light guide plate LGP.

The second sub-surface 301b of the first surface 301 includes a first end connected to the first sub-surface 301a and a distal second end spaced apart from the first sub-surface 301a. A distance between the third sub-surface 303 and the second sub-surface 301b increases as a distance from the first end of the second sub-surface 301b increases and as a distance from the distal second end of the second sub-surface 301b decreases.

The distal second end of the second sub-surface 301b of the first surface 301 does not make contact with the second surface 302. A passage connected to the inside of the mold 300 is defined between the second sub-surface 301b and the second surface 302. Referring to FIG. 12B, the light source unit LU and the portion of the light guide plate LGP are provided in the mold 300 through the passage in the providing of the light guide plate LGP and the light source unit LU (S40).

The second surface 302 faces the first surface 301 and is spaced apart from the first surface 301.

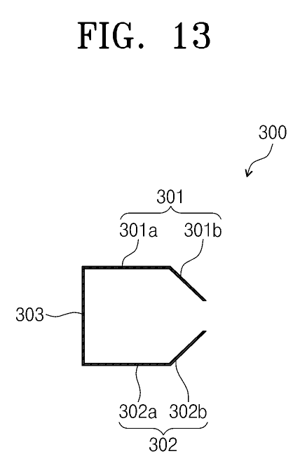

The shape of the mold 300 should not be limited to the above-mentioned shape. In an exemplary embodiment, for instance, the mold 300 may include two inclined surfaces. In detail, referring to FIGS. 6, 7 and 13, the second surface 302 may include or define a first sub-surface 302a connecting the third surface 303 to a second sub-surface 302b which extends from the first sub-surface 302a and is inclined with respect to the first surface 301. The first sub-surface 302a may be substantially parallel to the first surface 301 and the second sub-surface 302b is not parallel to the first surface 301. The first sub-surface 302a and the second sub-surface 302b are not overlapped with each other in the plan view, that is, in a direction from the first surface 301 to the second surface 302.

Where the connection member LA is formed by filling the mold 300 having the second sub-surface 302b of the second surface 302 with the resin RE, a portion of the connection member LA is formed as the inclined surface (refer to FIG. 6). In more detail, the portion of the connection member LA includes or defines the inclined surface which contacts or meets the lower surface UN (refer to FIG. 6) of the light guide plate LGP.

The second sub-surface 302b of the second surface 302 includes a first end connected to the first sub-surface 302a and a distal second end spaced apart from the first sub-surface 302a. A distance between the third sub-surface 303 and the second sub-surface 302b increases as a distance from the first end of the second sub-surface 302b increases and a distance from the distal second end of the second sub-surface 302b decreases.

The distal second end of the second sub-surface 302b of the second surface 302 does not make contact with the first surface 301. The mold 300 is open by a distance between the second sub-surface 302b of the second surface 302 and the second sub-surface 301b of the first surface 301 to define a passage of the mold. Referring again to FIG. 12B, the light source unit LU and the portion of the light guide plate LGP are provided in the mold 300 through the opening of the mold 300 in the providing of the light guide plate LGP and the light source unit LU (S40).

The third surface 303 connects the first surface 301 and the second surface 302 to each other. In more detail, the third surface 303 connects to the first and second surfaces 301 and 302 at first ends of the first and second surfaces 301 and 302.

When viewed from the third surface 303 of the mold 300 in the first direction DR1, the third surface 303 is not overlapped with the first sub-surface 301a of the first surface 301 and is overlapped with the second sub-surface 301b of the first surface 301.

When viewed from the third surface 303 of the mold 300 in the first direction DR1, the third surface 303 is not overlapped with the first sub-surface 302a of the second sub-surface 302 and is overlapped with the second sub-surface 302b of the second surface 302.

Referring to FIG. 12B, the providing of the light source unit LU and the portion of the light guide plate LGP in the mold 300 (S40) may include providing the printed circuit board CB to make contact with the second surface 302, but should not be limited thereto or thereby. That is, although not shown in figures, the printed circuit board CB may be disposed to make contact with the third surface 303.

As shown in FIG. 12C, the forming of the connection member LA (S50) includes the filling of the mold 300 having the light source unit LU and the portion of the light guide plate LGP therein with the resin RE. The forming of the connection member LA (S50) may include curing the resin RE after the mold 300 having the light source unit LU and the portion of the light guide plate LGP therein is filled with the resin RE. In addition, a cooling process may further be performed after the curing of the resin RE. The connection member LA is formed through the forming of the connection member LA (S50) and the connection member LA has the inclined surface by the inclined surface of the mold 300 as described above.

The preparing of the light guide plate LGP using an extrusion molding method (S10) may include forming a pattern in plural lengthwise extending in a first direction DR1 and arranged in a second direction DR2 perpendicular to the first direction DR1, at or on at least one surface of the light guide plate LGP. In detail, the preparing of the light guide plate LGP (S10) may include forming the pattern at or on at least one surface among the upper and lower surfaces UP and UN of the light guide plate LGP. According to exemplary embodiments, the forming of the pattern and the preparing of the light guide pattern LGP may be substantially simultaneously performed. Where the light guide plate LGP is manufactured using an extrusion roller on which a recess-forming pattern is defined, a relatively thin light guide plate LGP having the lengthwise extended pattern formed or defined thereon may be manufactured. As described above, the lengthwise extended pattern serves as the optical pattern shielding pattern.

According to one or more exemplary embodiment of the manufacturing method of the display device, the relatively thin light guide plate LGP having the shielding pattern formed thereon and the light source unit LU are each provided in the mold 300, and then the mold 300 is filled with the resin RE to form the connection member LA including the inclined surface. Accordingly, no additional cutting process is required and defects caused by a conventional cutting process are reduced or effectively prevented. As a result, the display device 10 according to the exemplary embodiments may have the relatively thin thickness, the superior shielding characteristics of the optical pattern and the superior light efficiency.

Although exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A display device comprising:
a light guide plate;
a light source unit adjacent to a side surface of the light guide plate, the light source unit comprising a printed circuit board and a light source which is on the printed circuit board; and
a connection member which connects the light guide plate and the light source unit to each other,
wherein
the light guide plate, the printed circuit board and the connection member together encapsulate the light source,
the connection member includes a first inclined surface thereof which contacts an upper surface of the light guide plate, and
the first inclined surface forms two angles with the upper surface of the light guide plate and an angle closer to the light source unit among the two angles is an acute angle.

2. The display device of claim 1, wherein the connection member further includes:
a first sub-connection portion thereof above the light guide plate and overlapped with a portion of the light guide plate in a plan view, the first sub-connection portion including the first inclined surface;
a second sub-connection portion thereof under the light guide plate and overlapped with the first sub-connection portion in the plan view; and
a third sub-connection portion thereof extended from the first sub-connection portion and overlapped with the light source in the plan view.

3. The display device of claim 2, wherein the first sub-connection portion has a trapezoid shape or a triangular shape in a cross-section thereof.

4. The display device of claim 2, wherein
the connection member further includes a second inclined surface thereof which contacts a lower surface of the light guide plate opposite to the upper surface thereof,
the second sub-connection portion includes the second inclined surface, and
the second inclined surface forms two angles with the lower surface of the light guide plate and an angle closer to the light source unit among the two angles is an acute angle.

5. The display device of claim 4, wherein the second sub-connection portion has a trapezoid shape or a triangular shape in a cross-section thereof.

6. The display device of claim 2, wherein the connection member further includes a fourth sub-connection portion extended from the third sub-connection portion and spaced apart from the first and second sub-connection portions.

7. The display device of claim 2, wherein the connection member further includes a fourth sub-connection portion extended from the second sub-connection portion and spaced apart from the first and third sub-connection portions.

8. The display device of claim 2, wherein
the light guide plate and the light source are spaced apart from each other, and
the connection member further includes a fifth sub-connection portion disposed between the light guide plate and the light source spaced apart from each other.

9. The display device of claim 1, wherein the light guide plate makes contact with the light source.

10. The display device of claim 1, wherein the light guide plate is an extrusion-molded plate.

11. The display device of claim 1, wherein the light guide plate has a thickness equal to or greater than about 100 micrometers and equal to or smaller than about 500 micrometers.

12. The display device of claim 1, wherein at least one of the upper surface and a lower surface of the light guide plate opposite to the upper surface thereof includes an optical pattern lengthwise extending in a first direction and arranged in a second direction perpendicular to the first direction.

13. The display device of claim 12, wherein the optical pattern has a lenticular shape or a prism shape.

14. The display device of claim 1, wherein the light guide plate and the connection member comprise different materials from each other.

15. A method of manufacturing a display device, comprising:
preparing a light guide plate formed by an extrusion molding process;
preparing a light source unit comprising a printed circuit board and a light source which is disposed on the printed circuit board;
preparing a mold comprising an inclined surface;
providing the light source unit and a portion of the extrusion-molded light guide plate within the mold comprising the inclined surface; and
filling the mold having the light source unit and the portion of the extrusion-molded light guide plate therein with a resin to form a connection member which together with the light guide plate and the printed circuit board encapsulates the light source.

16. The method of claim 15, wherein
the mold comprises a first surface, a second surface facing the first surface, and a third surface connecting first ends of the first surface and the second surface to each other,
the first surface includes:
a first sub-surface thereof extended from the third surface, and
a second sub-surface thereof extended from the first sub-surface and inclined with respect to the second surface, and
in a plan view, the first sub-surface is not overlapped with the second sub-surface.

17. The method of claim 16, wherein
the second surface includes:
a first sub-surface thereof extended from the third surface, and
a second sub-surface thereof extended from the first sub-surface of the second surface and inclined with respect to the first surface, and
in the plan view, the first sub-surface of the second surface is not overlapped with the second sub-surface of the second surface.

18. The method of claim 15, wherein the preparing the light guide plate comprises forming an optical pattern thereof lengthwise extending in a first direction and arranged in a second direction perpendicular to the first direction, on at least one surface of the light guide plate.

19. The display device of claim 2, wherein
the light guide plate, the connection member first sub-connection portion above the light guide plate and the connection member second sub-connection portion under the light guide plate each includes a light incident surface thereof, and
the light incident surfaces are coplanar with each other to define a light incident surface of the backlight unit.

20. The display device of claim 19, wherein
the light source includes an emission surface thereof which faces the light incident surface of the backlight unit, and
in a thickness direction of the light guide plate, a length of the light incident surface of the backlight unit is greater than a length of the emission surface of the light source.
